(19) United States
(12) Patent Application Publication
(10) Pub. No.: US 2014/0137974 A1
(43) Pub. Date: May 22, 2014

(54) ADHESIVE BACKED CABLING SYSTEM

(71) Applicant: 3M INNOVATIVE PROPERTIES COMPANY, St. Paul, MN (US)

(72) Inventors: Brent LUNCEFORD, Austin, TX (US); John P. LAMMERS, Austin, TX (US); Robert M. ANDERTON, Cedar Park, TX (US); Karl E. WOLF, Round Rock, TX (US); Paul H. BENSON, Austin, TX (US); Donald K. LARSON, Cedar Park, TX (US)

(73) Assignee: 3M INNOVATIVE PROPERTIES COMPANY, St. Paul, MN (US)

(21) Appl. No.: 14/062,180

(22) Filed: Oct. 24, 2013

Related U.S. Application Data
(60) Provisional application No. 61/727,201, filed on Nov. 16, 2012.

(51) Int. Cl. H02G 3/04; F16L 11/22

(52) U.S. Cl. CPC H02G 3/0487; F16L 11/22
USPC 138/108; 138/111; 138/177

(57) ABSTRACT

An duct for distributing transmission media is described herein. The duct has an elongated main body having a length and a lengthwise bore formed through the elongated main body. The elongated main body includes a generally flat bottom portion disposed adjacent to the bore and at least one strength member disposed lengthwise within the elongated main body. The at least one strength member defines a control surface disposed parallel to the flat bottom portion and intersecting the bore of the duct such that the transmission media longitudinally intersect with the control surface over a strained portion of the elongated main body when in a stressed state. An adhesive layer is disposed on an external surface of the flat bottom portion.

### CROSS REFERENCE TO RELATED APPLICATION

This application claims the benefit of U.S. Provisional Patent Application No. 61/727,201, filed Nov. 16, 2012, the disclosure of which is incorporated by reference herein in its entirety.

### BACKGROUND OF THE INVENTION

1. Field of the Invention

The present invention is directed to adhesive-backed cabling for in-building wireless or fiber to the home horizontal cabling applications. In particular, an adhesive backed cabling system is described that includes one or more strength members disposed at the neutral plane of the adhesive-backed cabling.

2. Background

More than half of all mobile communications originate from inside buildings. With the development of 3G and 4G smart phones and other data intensive mobile devices, increasing demand is being placed on wireless and wired infrastructure within buildings such as office buildings, schools, hospitals, and residential units. Better wired and wireless communication coverage is needed to provide the desired bandwidth to an increasing number of customers. However, the labor to install these enhanced wired and wireless systems in existing buildings can be costly, so a low cost and easy to install structured cabling solution to enhance wired and/or wireless coverage within a building is needed.

In-Building Wireless (IBW) Distributed Antenna Systems (DASs) are utilized to improve wireless coverage within buildings and related structures, such as arenas, campuses, pavilions, etc. Conventional DASs use strategically placed antennas or leaky coaxial cable (leaky coax) throughout a building to accommodate radio frequency (RF) signals in the 300 MHz to 6 GHz frequency range. Conventional RF technologies include TDMA, CDMA, WCDMA, GSM, UMTS, PCS/cellular, iDEN, and many others. Additional wireless signals which use an in-building wireless network can also include telemetry, WiFi, and public safety signals.

Conventional wired communications systems include enterprise grade Passive Optical Networks (PONs) and Ethernet over twisted pairs or optical fibers. Wired cabling can also be used for remote powering of optical fiber fed wireless access points and remote radios for the in building wireless system.

Outside the United States, carriers are required by law in some countries to extend wireless coverage inside buildings. In the United States, bandwidth demands and safety concerns will drive IBW applications, particularly as the world moves to current 4G architectures and beyond.

There are a number of known network architectures for distributing wireless communications inside a building. These architectures include choices of passive, active and hybrid systems. Active architectures generally include manipulated RF signals carried over fiber optic cables to remote electronic devices which reconstitute the electrical signal and transmit/receive the signal. Passive architectures include components to radiate and receive signals, usually a coaxial cable attached to discrete antennas or through a punctured shield leaky coax network. Hybrid architectures include native RF signal carried optically to active signal distribution points which then feed multiple coaxial cables terminating in multiple transmit/receive antennas. Specific examples include analog/amplified RF, RoF (Radio over Fiber, also known as RFoG, or RF over glass), fiber backhaul to pico and femto cells, and RoF vertical or riser distribution with an extensive passive coaxial distribution from a remote unit to the rest of the horizontal cabling (within a floor, for example). These conventional architectures can have limitations in terms of electronic complexity and expense, inability to easily add services, inability to support all combinations of services, distance limitations, or cumbersome installation requirements.

Conventional cabling for IBW applications includes RADIAFLEX™ cabling available from RFS (www.rfsworld.com), standard ½ inch coax for horizontal cabling, ⅞ inch coax for riser cabling, as well as standard optical fiber cabling for riser and horizontal distribution.

Physical and aesthetic challenges exist in providing IBW cabling for different wireless network architectures, especially in older buildings and structures. These challenges include gaining building access, limited distribution space in riser closets, and space for cable routing and management.

### SUMMARY

An adhesive backed duct for carrying transmission media for a distributed communication system are described herein. The exemplary ducts are less susceptible to issues arising from stresses on the duct that can degrade the performance of the transmission media carried therein.

According to an exemplary embodiment of the present invention, a duct for distributing transmission media has an elongated main body having a length and a lengthwise bore formed through the elongated main body. The elongated main body includes a generally flat bottom portion disposed adjacent to the bore and at least one strength member disposed lengthwise within the elongated main body. The at least one strength member defines a control surface disposed parallel to the flat bottom portion and intersecting the bore of the duct such that the transmission media longitudinally intersect with the control surface over a strained portion of the elongated main body when in a stressed state. An adhesive layer is disposed on an external surface of the flat bottom portion.

According to another exemplary embodiment of the present invention, a duct for distributing transmission media has an elongated main body having a length and a lengthwise bore formed through the elongated main body. The elongated main body includes a generally flat bottom portion disposed adjacent to the bore and at least one strength member disposed lengthwise within the elongated main body. The at least one strength member defines a constant length control surface intersecting the bore of the duct such that the transmission media longitudinally intersect with the control surface over a strained portion of the elongated main body when in a stressed state. An adhesive layer is disposed on an external surface of the flat bottom portion.

According to another exemplary embodiment of the present invention, a duct for distributing transmission media wrapped on a storage spool has an elongated main body having a length and a lengthwise bore formed through the elongated main body. The elongated main body includes a generally flat bottom portion disposed adjacent to the bore and at least one strength member disposed lengthwise within the elongated main body. The at least one strength member defines a constant length control surface intersecting the bore of the elongated main body. The storage spool has a core having a central axis. The duct is wrapped on the core such that at any point along the length of the duct, the control surface is defined by a control line that is parallel to the central axis of the core and intersects the transmission media over a substantial portion of the length of the elongated main body.

### BRIEF DESCRIPTION OF THE DRAWINGS

The present invention will be further described with reference to the accompanying drawings, wherein:

FIG. 1 shows a schematic view of an exemplary multi-dwelling unit having a converged in-building wireless network installed therein according to an embodiment of the present invention.

FIGS. 2A and 2B are two isometric views an exemplary adhesive-backed, media-filled duct in accordance with an aspect of the present invention;

FIG. 3 is a schematic cross-section of another exemplary media-filled duct in accordance with an aspect of the present invention;

FIG. 4 is a schematic cross-section of another exemplary media-filled duct in accordance with an aspect of the present invention;

FIG. 5 is a schematic cross-section of another exemplary media-filled duct in accordance with an aspect of the present invention;

FIG. 6 is a schematic cross-section of another exemplary media-filled duct in accordance with an aspect of the present invention;

FIG. 7 is an isometric view of another exemplary media-filled duct in accordance with an aspect of the present invention;

FIG. 8 is a schematic cross-section of another exemplary adhesive backed duct in accordance with an aspect of the present invention; and

FIGS. 9A and 9B are two views of an exemplary media-filled duct disposed on a spool in accordance with an aspect of the present invention;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE DRAWINGS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to an adhesive-backed cabling system comprising a flexible duct for in-building wireless (IBW) and wireline applications. The inventive adhesive-backed cabling solutions described herein can provide pathways for a plurality of transmission media, such as coaxial (coax) cables; twin axial (twinax) cable; optical fibers cables including individual optical fibers, optical fiber ribbon cables or bundled optical fibers; category cabling such as, but not limited to, Cat 5e cables and Cat 6 cables; and power distribution cabling. The exemplary adhesive-backed cabling system is designed with a low visual impact profile for better aesthetics and can provide for multiple channels of power, RF/cellular and/or data traffic to be distributed within a building or premises location such as a single family home, multi-dwelling unit or apartment building, an office building, a hospital, or a university, for example. In an alternative aspect, the exemplary adhesive-backed cabling system can be used in a distributed antenna system in outdoor structures where people tend to congregate.

These multiple signal pathways carried by the exemplary ducts can be dedicated to different carriers for each carrier needing wireless distribution within a building, or to providing different services such as data or voice transmission. These multiple signal pathways can also be dedicated to routing signals to different locations within a building or structure. The inventive adhesive-backed cabling system may be used above the ceiling or below the ceiling. Thus, the adhesive-backed cabling structure enables flexible network design and optimization for a given indoor environment or outdoor areas or structures including points of congregation such as an arena or a pavilion.

The adhesive-backed cabling structures or ducts, described herein, can be designed to accommodate most small forms of transmission media including optical fibers and/or electrical cables. For example, the adhesive-backed cabling structure may be sized to accommodate one of a copper ribbon cable, a fiber ribbon cable, bundled or unbundled individual optical fibers, a twin ax cable, a micro-coax cable, a twisted pair cable such as a CAT 5e cable or a CAT 6 cable, a coated wire, an uncoated wire, or an optical fiber drop cable. In an alternative embodiment, the exemplary adhesive-backed cabling structure can include one or more hollow buffer tubes suitable for use in blown optical fiber applications.

Conventional flexible cabling systems can be manufactured by extruding the flexible conduit or duct around the transmission media to be contained therein and then winding the media filled duct onto a cylindrical core of a transportation spool. If not properly designed, a length mismatch can result from shrinkage of the conduit after extrusion when there is excessive media in a bore of the conduit. The excessive media can interact with the walls surrounding the bore in a shrunken conduit causing deformation or damage in the optical fiber(s) contained therein. Deformation or damage in the optical fiber(s) can also occur during installation or during the lifetime of the product due to stresses or strains that are placed on the conduit and can cause unacceptable optical loss and affect product performance. In addition, interaction between stiffer conductor wires and optical fibers can cause deformation or micro bends in the optical fiber(s) in a shrunken conduit that can result in product rejection by field installers who are trained to recognize potential product defects.

Another issue faced in co-extruding the conduit with the transmission media is that the material used to form the duct can stretch and shrink during and after manufacture, which can further complicate the interaction between the media and the conduit. In some instances, a pressure sensitive adhesive or tape can applied to the conduit. The adhesive/tape can include a release liner to protect the adhesive surface prior to installation. The elongation characteristics of the material used to form the duct along with the interaction of the media and the conduit can affect the adhesive integrity and specifically the removal of the release liner from the duct during installation of the cabling system. Thus, it is necessary to stabilize the duct or conduit during manufacture, storage and installation.

To accomplish this, the exemplary adhesive back duct of the present disclosure incorporates at least one strength member into the extruded duct during manufacture of the duct. The at least one strength member can be coextruded with the duct or the duct material can be extruded around an existing strength member(s) such that the strength members are disposed within the walls of the duct. In this way, the material of duct is in intimate and bound contact with the strength member such that some of the exemplary properties of the strength member are imparted to the entire duct structure. These exemplary properties include both the tensile and elongation properties of the strength member. The type of strength member used in this exemplary new duct is selected such that the elongation properties of the strength members are close the elongation properties of the transmission media to be disposed within the bore of the duct this reducing or eliminating slack formation, possible kinking and excessive interaction between the different types of transmission media disposed within the bore of the exemplary duct.

In an exemplary aspect, the at least one strength members can be coextruded with the duct material around the transmission media to be contained therein. In an alternative aspect, the at least one strength members can be coextruded with the duct material to form an empty hollow duct. The empty duct can be slit along its length, and the transmission media can be introduced into the empty bore of the duct through the slit. Application of an adhesive tape/layer can seal the slit closed after the duct has been filled with the desired transmission media.

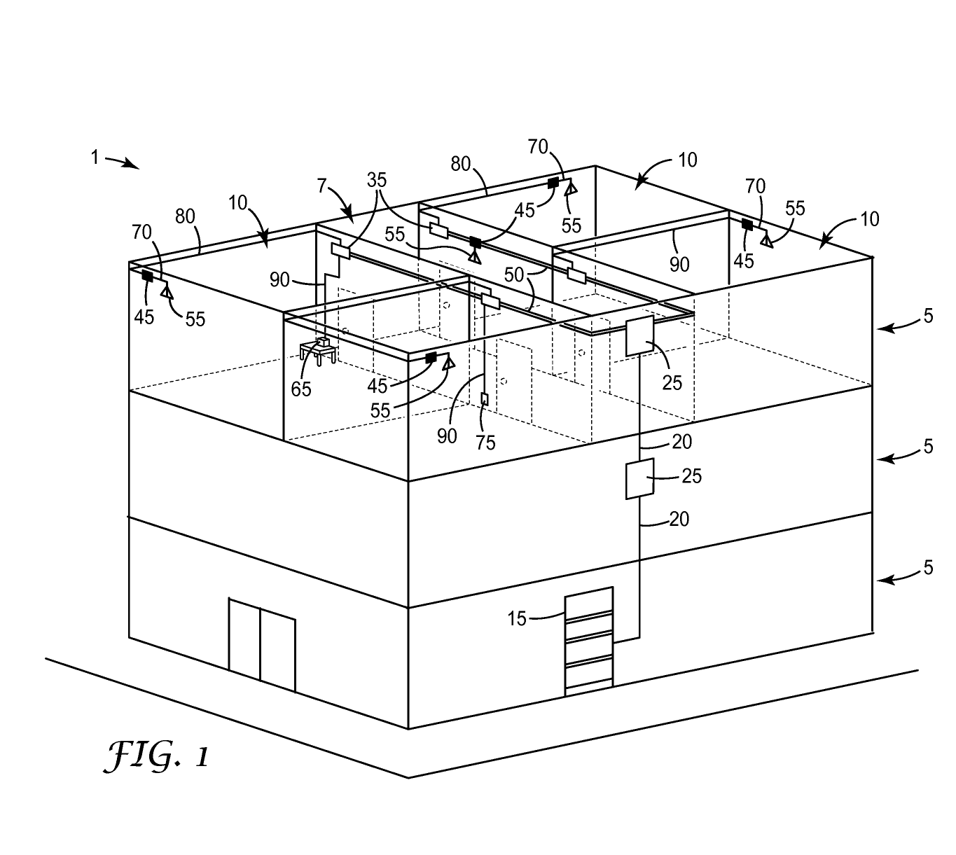

The exemplary filled ducts can be used in distributed communication systems such as may be found in an apartment building or other multi-dwelling unit (MDU). FIG. 1 shows an exemplary MDU 1 having an exemplary in-building communication system installed therein. The MDU includes four living units 10 on each floor 5 within two living units located on either side of a central hallway 7. While an exemplary in-building communication system is being described within the confines of an MDU, one of ordinary skill in the art will recognize that analogous in-building communication systems can be disposed in an office building, hospital, educational building, etc. Similarly, analogous communication networks can be installed in outdoor venues or structures where people tend to congregate.

A feeder cable (not shown) brings wired communications lines to and from building (e.g. MDU 1) from the traditional communication network and coax feeds bring the RF or wireless signals into the building from nearby wireless towers or base stations. All of the incoming lines (e.g. optical fiber, coax, and traditional copper) are fed into a main distribution facility or main distribution rack 15 in the basement or equipment closet of the MDU. The main distribution rack 15 organizes the signals coming into the building from external networks to the centralized active equipment for the in building converged network. Power mains and backup power can also be distributed through the main distribution rack. The main distribution rack(s) 15 can hold one or more equipment chassis as well as telecommunication cable management modules. Exemplary equipment located on the main distribution can include, for example, a plurality of RF signal sources, an RF conditioning drawer, a primary distributed antenna system hub, a power distribution equipment, and distributed antenna system remote management equipment. Exemplary telecommunication cable management modules can include, for example, a fiber distribution hub, a fiber distribution terminal and a patch panel.

Riser cables or trunk cables 20 carrying transmission media (communication cabling and/or power cabling) run from the main distribution rack 15 in the main distribution facility to the area junction boxes 25 located on each floor 5 of the building. In an exemplary aspect, an adhesive backed ducted trunk cabling solution can be used which utilizes the ducted cabling solution described herein. The area junction box provides the capability to aggregate horizontal fiber runs and optional power cabling on each floor and can serve as a break-out point for the trunked cabling in which the trunk cable(s) is broken out to a number of cabling structures containing optical fibers or other communication cables and/or power cables which are further distributed within the building by horizontal cabling structures 50 described above. These cabling structures can utilize the adhesive-backed cabling duct designs described herein. A point of entry box 35 is located in the central hallway 7 at each living unit to split off power and communication cables from the horizontal cabling 50 to be used within the living unit.

A remote radio socket 45 can be disposed over horizontal cabling 50 in central hallway 7 and can be connected to a distributed antenna 55 to ensure a strong wireless signal in the hallway.

The cables entering the living unit through point of entry box 35 can feed remote radio sockets 45 as well connecting to communication equipment 65 inside of each living unit or a wall receptacle 75 to which a piece of communication equipment can be connected by a fiber jumper (not shown). Exemplary communication equipment can include a single family unit optical network terminal (SFU ONT), desktop ONT, or similar device (e.g., a 7342 Indoor Optical Terminal, available from Alcatel-Lucent or a Motorola ONT1125GE Desktop ONT).

The optical fibers, coax cables and power cables which feed the remote radio socket can be disposed in wireless duct 80. Wireless duct 80 can be adhesively mounted to the wall or ceiling within the MDU. The wireless duct carrying one or more optical fibers, metallic communication lines and/or power lines within the duct structure are described herein.

The distributed antennas 55 can be connected to the remote radio socket 45 by a short length of coaxial cable 70. The antennas are spaced around the building so as to achieve thorough coverage with acceptable signal levels.

Optical drop fibers can be carried from the point of entry box 35 in the hallway to an anchor point within the living unit 10, such as wall receptacle 75 or a piece of communication equipment 65, via telecommunication duct 90. In a preferred aspect, the telecommunication duct 90 is a low profile duct that can be disposed along a wall, ceiling, under carpet, floor, or interior corner of the living unit in an unobtrusive manner, such that the aesthetics of the living unit are minimally impacted.

Thus, the exemplary adhesive backed, ducted cabling system, describe herein, can be used in four different parts of the in-building network (i.e. as a ducted trunk cable 20, as horizontal cabling 50, as a telecommunication duct 90 or as a wireless duct 80) or in localized outdoor distributed networks where people tend to congregate such as in or around college campuses, arenas, pavilions, etc. The difference between the different ducts that can be used a distributed network such as the in-building network described above is primarily the geometry (e.g. size and possibly cross-sectional shape) of duct needed to carry the necessary transmission media (type and number) for a given section of the network.

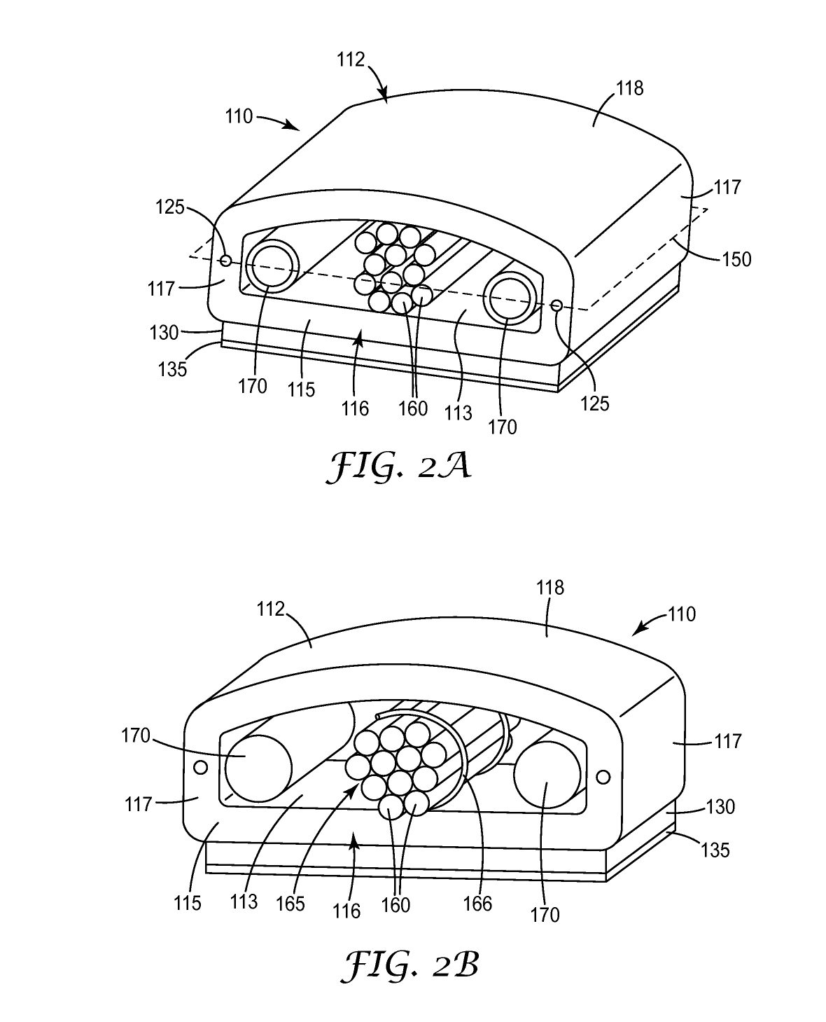

FIGS. 2A and 2B show two views of an exemplary duct 110 for distributing transmission media in a distributed communication network which utilizes an adhesive-backed, ducted cabling system. Duct 110 can have an elongated main body 112 having a bore 113 extending longitudinally therethrough. The bore is sized to accommodate a variety of transmission media that can include one or more communications lines (e.g. copper wires, optical fibers, or RF transmission lines) and/or one or more power lines. In the exemplary aspect shown in FIG. 2A, the transmission media included in the duct are a plurality of individual optical fibers 160 and two power lines 170 while in FIG. 2B the transmission media are an optical fiber bundle or module and two power lines.

Optical fiber bundle 165 is a grouping of individual fibers that are bound together within a buffer tube, a monofilament, a thread wrap 166 or a tape wrap. The optical fiber bundle 165 may contain, for example, two or more individual 250 micron or 900 micron buffer coated optical fibers 160. Placing the optical fibers in a bundle helps to keep the optical fibers segregated from any other transmission media disposed in the bore of the elongated duct which can prevent entrapment of loose optical fibers between the walls of the duct forming the bore and the other transmission media disposed within the bore of the duct reducing microbending losses as well as making it easier to extract one or more fibers from the duct at a junction point in the in-building network. In addition, minimizing the interactions of the optical fibers with other media component can minimize fiber pull back forces required to extract fiber from the exemplary adhesive-backed duct to make an optical connection via an optical fiber splice or an optical fiber connector.

In an exemplary aspect, the duct 110 can be pre-populated with the desired combination of transmission media depending on where in the in-building network the duct will be used. In an alternative aspect, the duct can be provided as an empty shell to which the transmission media can be added in the field.

In one aspect, duct 110 is a structure formed from a polymeric material such as polyvinyl chloride (PVC), a material with thermo oxidative resistance such as a flexible or semi-rigid polyaryl-based plastic, a flexible polyolefin including low smoke zero halogen elastomer resin, or a bio-based (i.e. cellulose) flexible plastic making it flexible, flame retardant. In an exemplary aspect, duct 110 can be made by a continuous extrusion process yielding long lengths of filled or unfilled ducts for use in in-building and/or outdoor congregation point communication networks. Providing long continuous lengths of duct can reduce the number of splice points needed in an in-building network simplifying installation of the network. Because the duct is flexible, duct 110 can be guided and bent around corners and other structures without cracking or splitting. However, the guiding of the duct around corners can apply localized stresses to the duct which can result in localized stretching and compression of the duct which can be detrimental to network performance. The structure of exemplary duct 110 minimizes or alleviates these concerns as will be described in more detail below. In an exemplary aspect, duct 110 can be coextruded around the transmission media to be contained within the bore of the duct, thus, simplifying the manufacture of the duct.

In the exemplary aspect shown in FIGS. 2A and 2B, duct 110 includes a flat bottom portion 115, two side walls 117 extending from the bottom portion and a domed top portion 118 formed atop the side walls opposite the bottom portion creating the elongated body of the duct having a bore 113 passing longitudinally therethrough. Thus, duct 110 has a domed rectangular profile. In an alternative aspect, the duct can have a rectangular profile, D-shaped profile, an omega-shaped profile or other geometrically shaped profile having at least one flat side.

The bottom portion of duct 110 provides support for the duct 110 as it is installed on or fastened to a wall or other generally flat surface, such as a wall, floor, ceiling, or molding. In a preferred aspect, the bottom portion includes a generally flat rear surface 116 suitable for applying an adhesive layer, such as an epoxy, a pressure sensitive adhesive, a transfer adhesive or double-sided tape to the duct which can be used to mount duct 110 to a mounting surface, a wall or other surface (e.g., a dry wall, concrete, or other conventional building material). In one alternative aspect, the adhesive applied to the rear surface of the bottom portion can be a pressure sensitive adhesive layer 130 with a removable liner 135 as shown in FIGS. 2A and 2B. In one exemplary aspect, the release liner can have a thickness between about 1 mil and about 5 mils, while in another exemplary aspect a thinner 0.5 mil release liner can be used. In use, the liner can be removed from the adhesive, and the duct can be applied to a mounting surface.

Duct 110 further includes strength members 125 disposed within each side wall 117 extending longitudinally with the elongated main body 112 and parallel to bore 113 of the duct. Strength member 125 can be a monofilament or multifilament thread such as that made from an aramid string or thread (e.g., a woven or non-woven Kevlar™ material) that is twisted or aramid yarn, a glass-reinforced plastic (GRP) strength member or a fiber-reinforced plastic (FRP) strength member. The aramid string or aramid yarn can be bonded or un-bonded. Alternative strength member materials include metallic wire or a fiberglass member. In an exemplary aspect, strength members 125 can be coextruded with the duct using conventional coextrusion technology. The strength members 125 can be essentially inelastic. Incorporation of the strength member into the elongated body of the duct helps to constrain the conduit material from stretching or shrinking during manufacturing, slitting, lamination, handling, installation, or over the lifetime of the product.

The position of the strength members within the elongated main body 112 of duct 110 define a control surface 150 with respect to the bore 113 of the duct and the transmission media 160, 170 disposed within the bore. Due to the inelasticity of the strength members, control surface can have an essentially constant length (i.e. the length of the elongated body) even when the duct is strained such as when the duct is wound onto a storage spool or routed around corners or other curved surfaces. For example, when the duct is bent around an outside corner on a mounting surface, the lower portion of the duct (i.e. the portion between the mounting surface and the control surface) will be in compression while the upper portion of the duct (i.e. the portion of the duct on the opposite side of the control surface from the mounting surface) will be in tension or stretched. The transmission media, which are also essentially inelastic, will be oriented along the control surface in this stressed portion of the duct since the length of control surface is essentially constant.

In the exemplary aspect shown in FIG. 2A, control surface 150 is disposed parallel to the bottom portion of the duct and intersects with the bore of the elongated body. In addition, the transmission media will lie along (or intersect with) the control surface over a substantial length the stressed portion of the duct. Locating the strength member(s) in the control plane (1) prevents media-to-duct length mismatch which in turns allow complex material interaction that can cause bends or deformation in the transmission media (e.g. optical fibers) contained within the duct/raceway; (2) prevents or minimizes duct shrinkage after extrusion and throughout the lifetime of the duct disposed in an in-building communication network; (3) prevents adhesive layer liner discontinuities or delamination that can result in the separation of the liner from the adhesive layer and preserves the integrity of the adhesive layer and liner; and (4) aids in keeping the duct/raceway oriented properly as it enters lamination equipment, installation tools, and other system components of the in-building communication network, such as junction boxes, sockets, remote radio unit enclosures, antenna, or antenna enclosures, corner pieces and to ensure proper orientation of the duct once it has been mounted onto a mounting surface. Elongated main body 112 is asymmetric with respect to the control surface 150.

Once the exemplary duct has been installed onto a mounting surface such as a wall or ceiling, the transmission media disposed within duct 110 can be accessed via a window cut in the top portion of the duct. In the embodiment shown in FIGS. 2A and 2B, the optical fiber communication lines 160 can be connected to drop fibers of a particular living unit in an MDU (or an office, class room or other sub-structure in a premises or enterprise network). In this particular exemplary aspect, a first fiber from duct 110 can be coupled, for example, to drop fiber cable from a particular living unit in an in-building wireless, enterprise or premises network. In another aspect, more than one fiber from the duct can be accessed at a particular drop or point of entry location. The transmission media can be accessed either through a separate window cut made to the conduit portion of the duct.

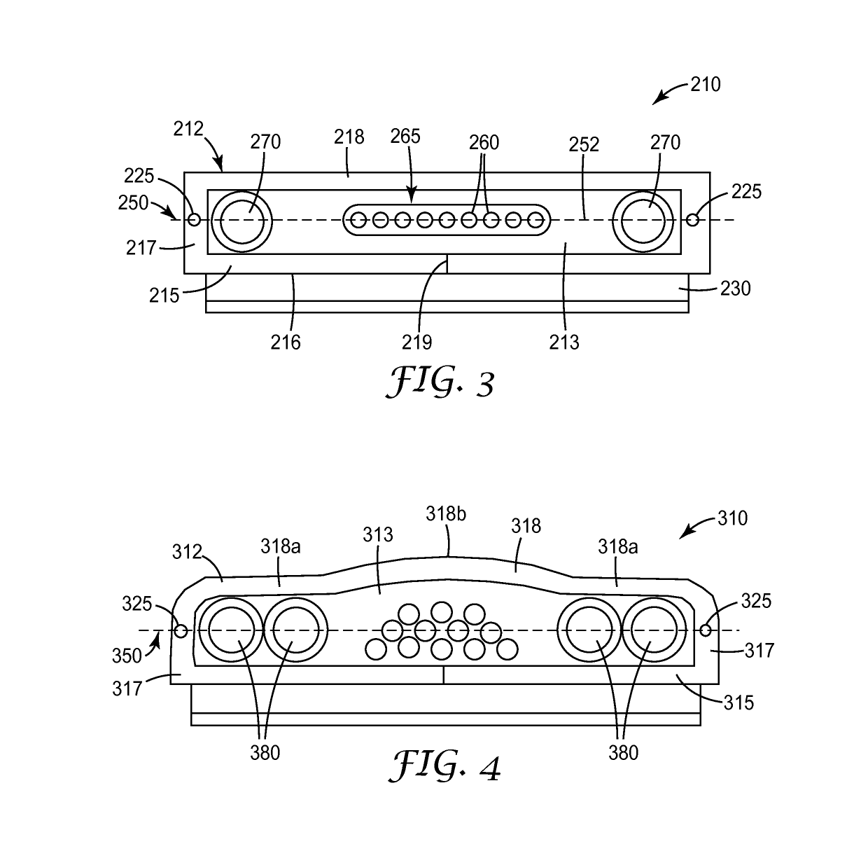

In one aspect, the optical fibers 160 disposed within duct 110 can be a tight bend radius, or traditional optical fiber. Such an optical fiber cable is commercially available as BendBright XS™ Single Mode Optical Fiber, from Draka Communications. Also in this aspect, an exemplary drop cable comprises a 2.9 mm jacketed drop cable commercially available as ez Patch cabling and ez Drop cabling from Draka Communications. In another alternative aspect, the optical fibers within the duct can be in the form of one or more optical fiber ribbon cables, such as ribbon cable 265 shown in FIG. 3. The power lines 170 disposed within duct 110 can be bare or dielectric coated wires of a gauge sufficient to carry power to the remote electronics within the in-building communication network.

In an alternative aspect, the transmission media can include one or more copper communication lines in the form twisted pair copper wires. Alternatively, the transmission media can include one or more RF transmission line in the form of a coaxial cable, a leaky coax cable, a micro coaxial cable, or a twinax cable such as is available from 3M Company (St. Paul, Minn.).

FIG. 3 is a schematic cross-sectional view of a second embodiment of an exemplary duct 210 for distributing transmission media in an in-building adhesive backed, ducted cabling system. Duct 210 has a rectangular profile has an elongated main body 212. The elongated main body comprises a flat bottom portion 215, two side walls 217 extending from the bottom portion and a flat top portion 218 formed atop the side walls opposite the bottom portion creating the elongated main body of the duct defining a bore 213 passing longitudinally therethrough.

The bore 213 is sized to accommodate a variety of transmission media that can include one or more communications lines (copper or optical fiber, one or more RF transmission lines) and/or one or more power lines. In the exemplary aspect shown in FIG. 3, the transmission media included in the duct includes another bundled grouping of optical fibers in the form of an optical fiber ribbon cable 265 containing eight individual optical fibers 260 and two power lines 270.

The bottom portion 215 of duct 210 provides support for the duct as it is installed on or fastened to a wall or other generally flat surface, such as a wall, floor, ceiling, or molding. In a preferred aspect, the bottom portion includes a generally flat rear surface 216 suitable for applying an adhesive layer 230 that can be used to mount duct 210 to a mounting surface, a wall or other surface (e.g., a dry wall, concrete, or other conventional building material).

Duct 210 has an access slit 219 disposed in the bottom portion 215 of the elongated body. In this exemplary embodiment, duct 210 can be extruded independent of the transmission media to be contained therein. The access slit allows the duct to be filled with the transmission media prior to the lamination of adhesive layer 230 on to the rear surface 216 of the bottom portion of the elongated main body, thus allowing a greater degree of customization in the transmission media disposed within the duct. In an alternative aspect, duct 210 can have the access slit disposed in one of the side walls 217 or in top wall 218 rather than through the bottom portion to allow insertion and removal of transmission media in the field when the in-building communication system is upgraded or expanded.

Duct 210 also includes strength members 225 disposed within each side wall 217 extending longitudinally with the elongated main body 212 and parallel to bore 213 of the duct. Strength member 125 can be an aramid string or thread (e.g., a woven or non-woven Kevlar™ material) that is twisted or aramid yarn, a glass-reinforced plastic (GRP) strength member or a fiber-reinforced plastic (FRP) strength member. In an exemplary aspect, strength members 225 can be coextruded with the duct using conventional coextrusion technology. Incorporation of the strength member into the elongated body of the duct helps to constrain the conduit material from stretching or shrinking during manufacturing, slitting, lamination, handling, installation, or over the lifetime of the product.

The position of the strength members 225 within the elongated main body 212 of duct 210 define a control surface 250 (extending into the page of FIG. 3). In the exemplary aspect shown in FIG. 3, control surface 250 is disposed parallel to the bottom portion 215 of the duct and intersects with the bore 213 of the elongated main body 212 and further intersecting with the transmission media 265, 270 over a substantial length of the transmission media and/or the elongated main body 212. At any point along the length of the duct 210, the control surface 250 is defined by a control line 252. Duct 210 is symmetric with respect to the control surface.

FIG. 4 is a schematic cross-sectional view of a third embodiment of an exemplary duct 310 for distributing transmission media in an in-building adhesive backed, ducted cabling system. Duct 310 has a partially domed rectangular profile has an elongated main body 312. The elongated main body comprises a flat bottom portion 315, two side walls 317 extending from the bottom portion and a partially domed top portion 318 formed atop the side walls opposite the bottom portion creating the elongated main body of the duct defining a bore 313 passing longitudinally therethrough. Partially domed top portion 318 comprises a domed central segment 318b flanked on either side by a relatively flat side segment 318a. This partially domed rectangular profile can provide additional clearance in the central portion of the duct to accommodate a greater number of optical fiber communication lines or to provide additional clearance between the optical fiber communication lines and the elongated body to reduce the force necessary to extract the optical fiber communication lines from the duct which could be a benefit in networks with long spans between nodes or where the duct needs to be routed around a number of bends or corners between access points.

Duct 310 also includes a plurality of small diameter hollow tubes 380 suitable for use in blown optical fiber applications. The tubes can have an outside diameter of between about 3 mm and about 6 mm. The tubes allow blowing up to four 250 μm optical fibers inside each tub over a distance up to a few hundred feet. Exemplary tubes can be formed of polyvinyl chloride (PVC), high density polyethylene or another polyolefin via a conventional extrusion process. Flame retardants can be added to the polymer resin during extrusion if flame retardancy is needed. A duct with plurality tubes may allow easy customization of the transmission media in the duct can be prepared with a plurality of tubes and the optical fibers can be blown into the duct while it is still on the storage spool rather than having to unroll the duct to insert the fibers through an access slit. Alternatively, a duct having one or more empty tubes can be installed in the distributed network and new optical fibers can be blown into the tubes in the field to increase capacity. Duct 310 is shown with four tubes although a lesser or greater number of tubes can be disposed within the exemplary duct structures disclosed herein. Once the fibers have been blown into the tubes, they are analogous to the fiber bundles previously described.

As before duct 310 also includes strength member 325 disposed within each side wall 317 extending longitudinally with the elongated main body 312 to geometrically stabilize the duct during manufacturing, slitting, lamination, handling, installation, or over the lifetime of the product. Elongated main body 312 is asymmetric with respect to the control surface 350 whose position is set by the position of strength member 325.

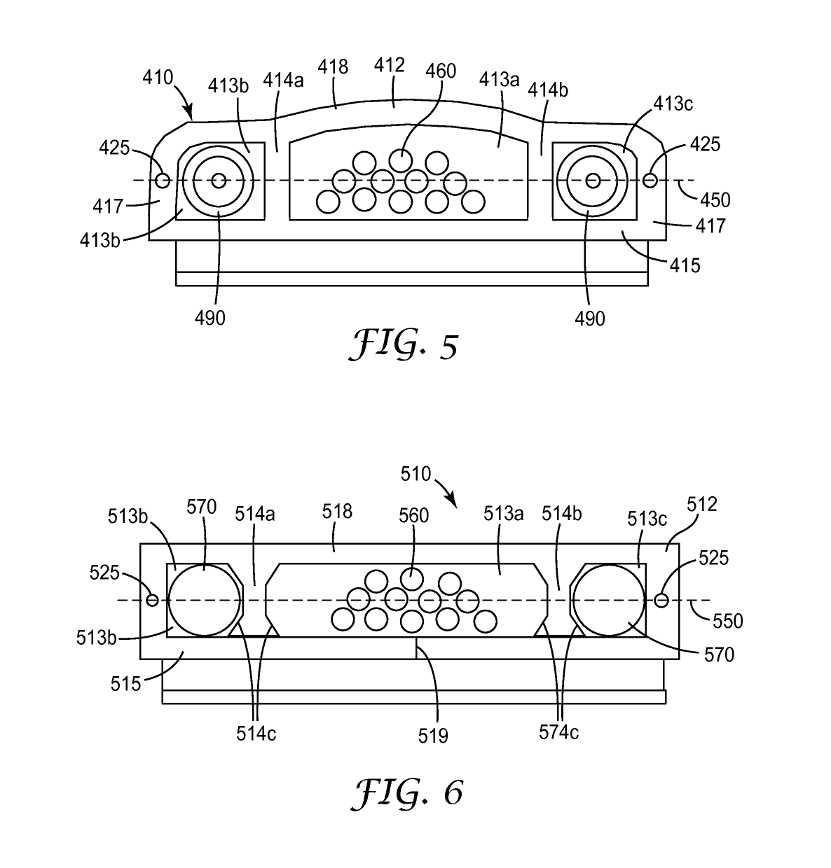

FIG. 5 is a schematic cross-sectional view of a fourth embodiment of an exemplary duct 410 for distributing transmission media in an in-building adhesive backed, ducted cabling system that is similar to duct 310 described previously with respect to FIG. 4. Duct 410 has a partially domed rectangular profile and an elongated main body 412. The elongated main body comprises a flat bottom portion 415, two side walls 417 extending from the bottom portion and a partially domed top portion 418 formed atop the side walls opposite the bottom portion creating the elongated main body of the duct defining a bore passing longitudinally therethrough. Partially domed top portion 418 comprises a domed central segment flanked on either side by a relatively flat side segment.

Duct 410 also includes strength members 425 disposed within each side wall 417 extending longitudinally with the elongated main body 412 to geometrically stabilize the duct during manufacturing, slitting, lamination, handling, installation, or over the lifetime of the product. The elongated main body 412 is asymmetric with respect to the control surface 450 whose position is set by the position of strength members 425.

In addition, duct 410 has a pair of spaced apart septa 414a, 414b separating the bore into a main channel 413a and two auxiliary side channels 413b, 413c allowing the separation of different categories of transmission media. In the exemplary aspect shown in FIG. 5, septa 414a and 414b are integrally formed with the duct such that they interconnect the base portion and the top portion. In particular, the septa can help support the top portion to maintain the open structure of main channel 413a and/or the two auxiliary side channels 413b, 413c against collapse when an external force is applied to the top portion of the elongated body.

In this embodiment, the elongated main body 412 of duct 410 is extruded around the transmission media. The transmission media shown in FIG. 5 include optical fiber communication lines 460 disposed within the main channel 413a of the bore while RF transmission lines (coaxial cables) 490 resides in each of the auxiliary side channels 413b, 413c. Thus, the septa can eliminate the intermingling of different types of transmission media which could cause loss in the signals carried by the transmission media due to bending or deformation.

Duct 510 of FIG. 6 is similar to the rectangular profile duct 510 described previously with respect to FIG. 3, except duct 510 further includes a pair of spaced apart septa 514a, 514b separating the bore into a main channel 513a and two auxiliary side channels 513b, 513c allowing the separation of different categories of transmission media. In the exemplary aspect shown in FIG. 6, the optical fiber communication lines 560 can be disposed within the main channel 513a of the bore while a power line 570 resides in each of the auxiliary side channels 513b, 513c thus elimination the intermingling of different types of transmission media which could cause loss in the signals carried by the transmission media.

In this exemplary aspect, septa 514a, 514b extend from the top portion 518 of the duct, but are not connected to the bottom portion 515 of the elongated body. Each of the septa can include angled footer portions 514c on one or both ends of the septa where it contacts the top portion and/or the bottom portions. The septa, shown in FIG. 6, have footer portions on both ends of each septa. The footer portions can help reinforce the structure of the duct as well as constrain the movement of the transmission media within the auxiliary side channels 513b, 513c.

The elongated main body 512 is essentially symmetric with respect to the control surface 550 where the control surface intersects with strength members 525, main channel 513a and the auxiliary side channels 513b, 513c as well as the transmission media (i.e. bare power conductors or wires 570 and optical fibers 560) disposed in the main channel and the auxiliary side channels. The only point of asymmetry in duct 510 is an access slit 519 disposed through the bottom portion 515 of the elongated main body 512. The access slit allows transmission media to be added to main channel 513a and the two auxiliary side channels 513b, 513c by simply opening up the elongated body and inserting the transmission media into the appropriate channel.

Advantages of duct 410, 510 include knowing the location of the various transmission media types within the duct without having to open the duct for visual inspection. Because duct 410, 510 is made from a flexible dielectric material, bare power conductors 570 can be placed in two auxiliary side channels 513b, 513c of duct 510 as shown in FIG. 6 which may allow more straight forward electrical connections to be made with the power lines since there is no insulating coating to penetrate or remove.

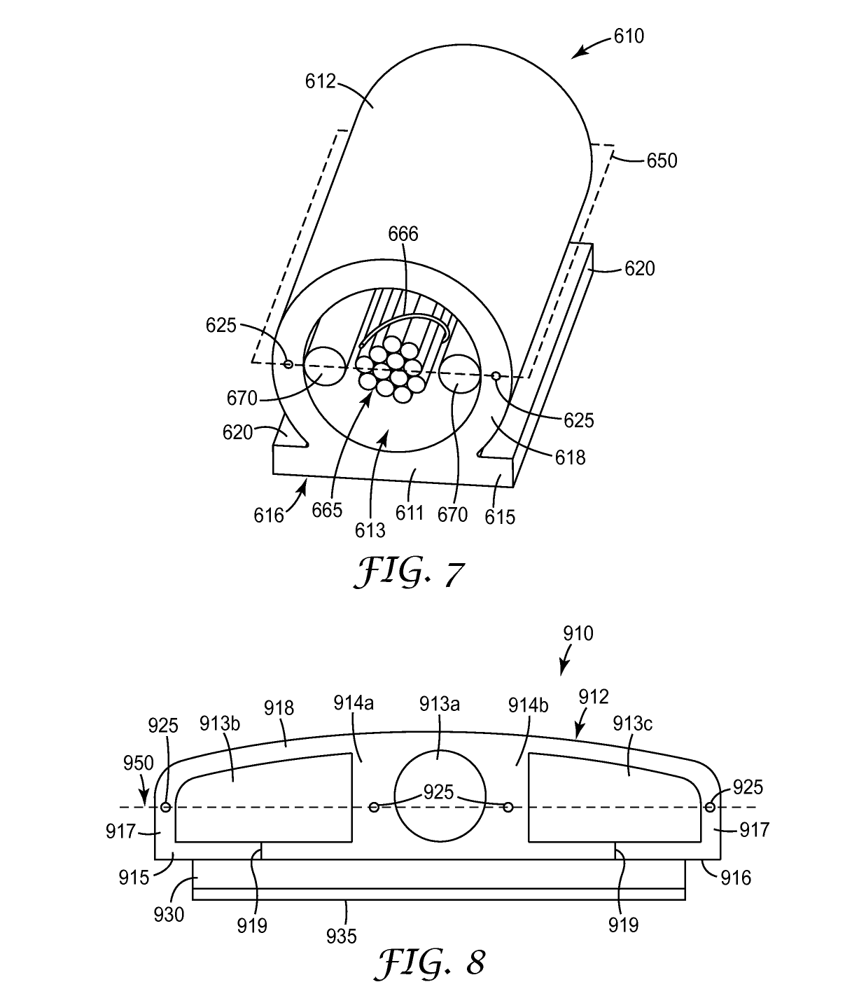

FIG. 7 shows another exemplary duct 610 for distributing transmission media comprising a pair of strength members to stabilize the duct during manufacture, slitting, lamination, handling, installation, and in use over the lifetime of the product. Duct 610 can have an elliptical elongated main body 612 having a bore 613 extending longitudinally therethrough disposed on a substantially flat bottom portion 615. In an exemplary aspect, elongated body and the bottom portion are integrally formed to provide a continuous monolithic structure.

The bore through the elongated body is sized to accommodate a variety of transmission media that can include one or more communications lines (e.g. copper wires, optical fibers, or RF transmission lines) and/or one or more power lines. In the exemplary aspect shown in FIG. 7, the transmission media included an optical fiber bundle 665 and two power lines 670. The optical fiber bundle 665 is a grouping of twelve individual fibers that are bound together by a thread wrap 666.

Bottom portion 615 can be wider than connection region 611 between the elongated body and the bottom portion forming a flange 620 on either side of the elongated body. In the exemplary aspect shown in FIG. 7, duct 610 has a flange extending from both sides of the connection region between the elongated body and the bottom portion. In an alternative aspect, the bottom portion can have a single flange extending from the connection region. The bottom portion 615 of duct 610 provides support for the duct as it is installed on or fastened to a wall or other generally flat mounting surface. In a preferred aspect, the bottom portion includes a generally flat rear surface 616 suitable for applying an adhesive layer (not shown).

Additionally, duct 610 further includes strength members 625 disposed within the wall 618 of the elongated main body 612 and extending longitudinally with the main body parallel to bore 613. Strength members 625 can be an aramid string or thread (e.g., a woven or non-woven Kevlar™ material) that is twisted or aramid yarn, a glass-reinforced plastic (GRP) strength member or a fiber-reinforced plastic (FRP) strength member. In an exemplary aspect, strength members 625 can be coextruded with the duct using conventional coextrusion technology. Incorporation of the strength member into the elongated body of the duct helps to constrain the conduit material from stretching or shrinking during manufacturing, slitting, lamination, handling, installation, or over the lifetime of the product.

The position of the strength members 625 within the elongated main body 612 of duct 610 define a control surface 650 with respect to the bore 613 of the duct and the transmission media 665, 670 disposed within the bore. In the exemplary aspect shown in FIG. 7, control surface 650 is disposed parallel to the bottom portion 615 of the duct and intersects with the bore of the elongated body and further intersecting with the transmission media over a substantial length of the transmission media and/or the elongated main body 612. Elongated main body 612 is asymmetric with respect to the control surface.

FIG. 8 is a schematic cross-sectional view of another embodiment of an exemplary duct 910 for distributing transmission media in an in-building adhesive backed, ducted cabling system that is similar to duct 110 described previously with respect to FIG. 2. Duct 910 has a partially domed rectangular profile has an elongated main body 912. The elongated main body comprises a flat bottom portion 915, two side walls 917 extending from the bottom portion and a domed top portion 918 formed atop the side walls opposite the bottom portion creating the elongated main body of the duct defining a bore passing longitudinally therethrough.

Duct 910 also includes a pair of spaced apart septa 914a, 914b separating the bore into a sealed main channel 913a and two auxiliary side channels 913b, 913c allowing the separation of different categories of transmission media. The bottom portion of the duct under each of the auxiliary side channels includes an access slit 919 to allow insertion of transmission media into the auxiliary side channels prior to lamination of an adhesive layer 930 to the flat rear surface 916 of the bottom portion 915. Transmission media can be inserted into the sealed main channel from the terminal end of the duct, such as by pushing or feeding the transmission media into the duct. The main channel 913a of duct 910 would also be well suited for blown optical fiber installations.

Duct 910 also includes strength member 925 disposed within each side wall 917 as well as within each of the septa 914a, 914b, the strength members extend longitudinally within the elongated main body 912 parallel to the main and auxiliary channels to geometrically stabilize the duct during manufacturing, slitting, lamination, handling, installation, or over the lifetime of the product. The elongated main body 912 is asymmetric with respect to the control surface 950 whose position is set by the position of strength member 925.

As mentioned previously, designing a duct where the transmission media can be disposed along a control surface within the main body of the duct can facilitate manufacture, transport, handling and installation of the duct. For example, the exemplary ducts described herein are typically wrapped on to a storage spool 800 as part of the manufacturing process due to the long continuous length of the ducts. In an exemplary aspect, the length of duct wrapped on a spool can be from tens of meters to hundreds or thousands of meters.

Typically, the winding of the duct onto the spool is done under tension and the duct can stretch when even a modest tension is applied due to the elastomeric nature of the duct. However the transmission media within the duct are essentially inelastic. Thus, it would seemingly be desirable if the duct did not stretch at all. However, the path length of the top portion of a duct is different from the path length of the adhesive layer, which is disposed on the bottom surface of the bottom portion of the duct, simply due to the height of the duct.

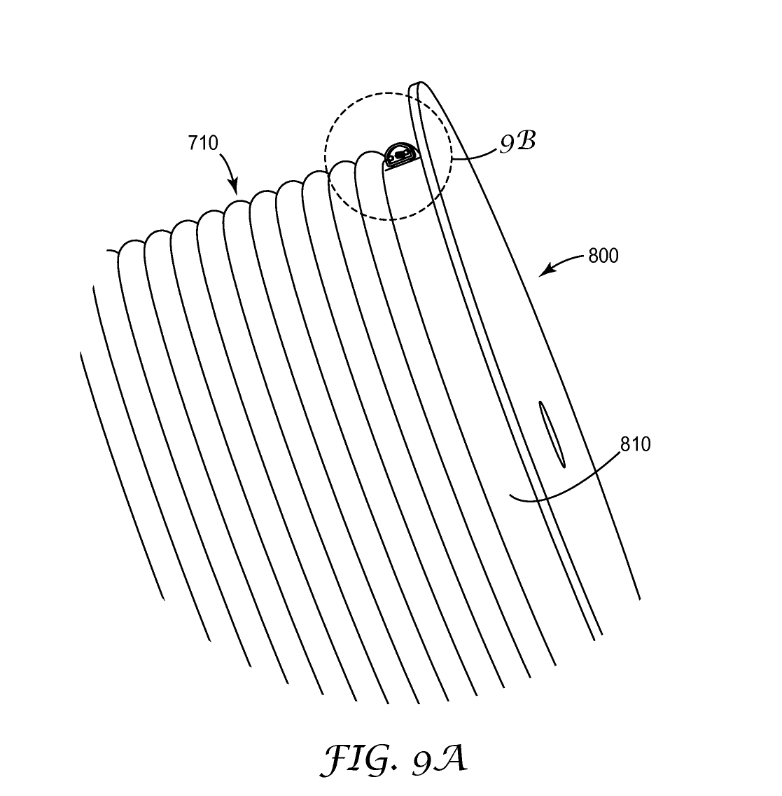

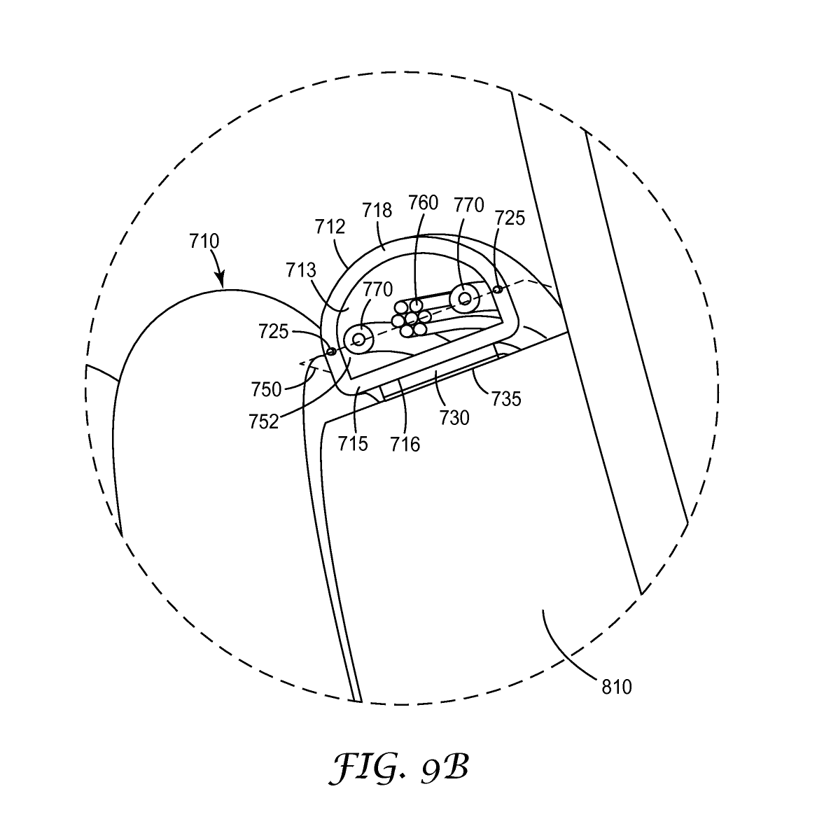

So in fact what is needed is a duct that is essentially inelastic in the region occupied by the transmission media (i.e. at control surface), but which can also be stretched or be compressed in a region outside of the inelastic region (i.e. in the portions of the duct not occupied by the transmission media. FIGS. 9A and 9B show how the exemplary ducts of the current invention satisfy these opposing criteria. FIG. 9A shows a length of an exemplary duct 710 wrapped onto a core 810 of a storage spool 800. FIG. 9B shows a close-up end view of duct 710 disposed on the core 810 of a storage spool.

Duct 710 has an elongated main body 712 with a D-shaped profile having a flat bottom portion 715 and a semi-circular cover portion 718 integrally formed with the base portion defining a bore 713 passing longitudinally therethrough. The bore 713 is sized to accommodate a variety of transmission media (i.e. seven optical fibers 760 and two power lines 770).

The bottom portion 715 of duct 710 includes a generally flat rear surface 716 suitable for applying an adhesive layer 730 and a liner disposed on the surface of the adhesive layer opposite the rear surface that can be used to attach the duct to a mounting surface (e.g., a wall, ceiling, etc.).

Duct 710 also includes a strength member 725 disposed on opposite sides and within the semi-circular cover portion 718 and extending longitudinally with the elongated main body 712 and parallel to bore 713. The position of the strength members 725 within the elongated main body 712 of the duct define a control surface 750 (extending into the page of FIG. 9B). In the exemplary aspect, control surface 750 is disposed parallel to the bottom portion 715 of the duct as it wraps around the core of the storage spool. The control surface intersects with the bore 713 of the elongated main body 712 and further intersecting with the transmission media 760, 770 over a substantial length of the transmission media and/or the elongated main body 712. At any point along the length of the duct, the control surface is defined by a control line 752.

The portion of the duct above the control surface is in tension and the portion of the duct below the control surface is in compression when the duct is wrapped around the storage spool 800. Thus, the region of the duct along the control surface is inelastic due to the presence of strength members 725 while the portion above the control surface is subject to elongation (stretching) and the portion of the duct below the control surface is in compression. Because the transmission media are effectively inelastic, the transmission media will be preferentially disposed in the region of the duct adjacent to the control surface and in fact the will intersect the control surface along a substantial portion of their length when the duct is in the strained by wrapping it around a storage spool.

The duct can be subjected to more localized strains resulting in the orientation of the transmission media along the control surface within the duct such as when the duct is wound on a storage spool; is attached to a curved mounting surface, or is routed around an inside or outside corner where two mounting surface meet.

Another advantage of a strength members in the walls of the duct on opposite sides of the bore is that the two parallel strength members prevent twisting of the duct due to stored stresses from manufacturing the duct. The exemplary ducts described herein will maintain their orientation when the duct is removed from the storage spool making it easier to handle and install than conventional wall mounted cabling products.

The adhesive-backed cabling structures or ducts described above can be used with passive optical LAN, RoF DAS, split radio, software defined radio, pico cell, and femto cell in-building communication networks or communication networks in outdoor congregation points (e.g. arenas, stadiums, campuses, pavilions, etc). In particular, the cabling system can use the inventive adhesive-backed cabling structure in a distributed antenna system that can be mounted to a vertical mounting surface such as a wall or a horizontal mounting surface such as a ceiling via the adhesive layer disposed on a rear surface of the duct. In an exemplary installation, the adhesive-backed cabling structure can be mounted to the wall of the building just below the ceiling.

In one exemplary use, the adhesive-backed cabling structure described herein can be used as part of a passive copper coax distribution architecture. In this architecture, some of the transmission media within the adhesive-backed cabling structure can be coax cables (e.g. standard coax cables, micro-coax cables or twinax coax cables) with only a head-end active component. The adhesive-backed cabling structure will provide the communication conduit between the active head end component and the antennas distributed throughout the building. Thus, this system can be implemented to connect the discrete distributed antennas to the horizontal coax channels with conventional splitters, taps, and/or couplers. In this manner, multiple service carriers can utilize the adhesive-backed cabling structure as horizontal cabling. This type of architecture can work with many different RF protocols (e.g., any cellular service, iDEN, Ev-DO, GSM, UMTS, CDMA, and others).

In one alternative aspect, the exemplary adhesive-backed cabling structure can include multiple coax cables configured to connect to separate antennas of a multiple-input and multiple-output (MIMO) antenna system, e.g., a 2×2 MIMO antenna system, a 4×4 MIMO antenna system, etc. In another alternative aspect, first and second coax conductors can be coupled to a single antenna system with cross-polarized antenna elements.

In another example, the exemplary adhesive-backed cabling structure described herein can be used as part of an active analog distribution architecture. In this type of architecture, RF signal distribution can be made over coax or fiber (RoF) transmission media. In this architecture, the adhesive-backed cabling structure can be combined with selected active components, where the types of active components (e.g., 0/E converters for RoF, MMIC amplifiers) are selected based on the specific architecture type. This type of architecture can provide for longer propagation distances within the building and can work with many different RF protocols (e.g., any cellular service, iDEN, Ev-DO, GSM, UMTS, CDMA, and others).

Other combinations of transmission media can be incorporated into the exemplary duct structures described herein based on the type of in-building communication network being installed.

The exemplary adhesive-backed cabling structures described herein can be used in in-building communication networks where there is a lack of established horizontal pathways from main distribution boxes to distributed antennas or end user dwellings. For buildings with drywall ceilings and few or no access panels, the adhesive-backed cabling structure of the present invention can be installed without having to enter the existing drywall ceiling since it can be attached to the surface of a wall or ceiling in an inconspicuous manner. For installations in older buildings in which the blueprints are missing or inaccurate, the adhesive-backed cabling structure can be installed on the basis of a visual survey, and can be placed to minimize or eliminate the need to disturb existing elaborate trim and hallway/room decorum. In addition, the need to establish major construction areas can be avoided.

The adhesive-backed cabling structure can provide for routing signals to different locations within a building, such as “lunch room,” “conference room,” “meeting room”, etc. The mix and match cable options allows for a separate channel or signal pathways to be set up independent of the other channels, if needed. This type of configuration can provide enhanced signal transmission to key locations within the building without affecting other channels.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A duct for distributing transmission media, comprising:
an elongated main body having a length and comprising a lengthwise bore formed through the elongated main body and a generally flat bottom portion disposed adjacent to the bore;
at least one strength member disposed lengthwise within the elongated main body and defining a control surface disposed parallel to the flat bottom portion and intersecting the bore of the duct such that the transmission media longitudinally intersect with the control surface over a strained portion of the elongated main body when in a stressed state; and
an adhesive layer disposed on an external surface of the flat bottom portion.

2. The duct of claim 1, wherein the transmission media intersect with the control plane over a substantial length of the duct.

3. The duct of claim 1, wherein the elongated main body is asymmetric relative to the control plane.

4. The duct of claim 1, wherein the elongated main body is symmetric relative to the control plane.

5. The duct of claim 1, wherein the transmission media can be at least one of copper communication lines, optical fiber communication lines, RF communication lines and power lines.

6. The duct of claim 1, wherein the transmission media can be a combination of at least two of copper communication lines, optical fiber communication lines, RF communication lines and power lines.

7. The duct of claim 1, further comprising one or more septa disposed within the bore and dividing the bore into a main channel and one or more auxiliary channels.

8. The duct of claim 7, wherein different categories of transmission media can be disposed in the main channel and the one or more auxiliary channels.

9. The duct of claim 7, wherein one of the main channel and the one or more auxiliary channels can be used to accommodate blown optical fibers.

10. The duct of claim 1, comprising two strength members disposed lengthwise within the elongated main body and on opposing sides of the bore.

11. The duct of claim 1, further comprising at least one hollow tube to accommodate blown optical fibers.

12. A duct for distributing transmission media, comprising:
an elongated main body having a length and comprising a lengthwise bore formed through the elongated main body and a generally flat bottom portion disposed adjacent to the bore; at least one strength member disposed lengthwise within the elongated main body and defining a constant length control surface intersecting the bore of the conduit portion such that the transmission media longitudinally intersect with the control surface over a strained portion of the elongated main body; and an adhesive layer disposed on an external surface of the flat bottom portion.

13. The duct of claim 12, wherein the transmission media intersect with the control plane over a substantial length of the duct.

14. The duct of claim 12, wherein the elongated main body is asymmetric relative to the control plane.

15. The duct of claim 12, wherein the elongated main body is symmetric relative to the control plane.

16. The duct of claim 12, wherein the transmission media can be at least one of copper communication lines, optical fiber communication lines, RF communication lines and power lines.

17. The duct of claim 12, further comprising one or more septa disposed within the bore and dividing the bore into a main channel and one or more auxiliary channels, wherein different categories of transmission media can be disposed in the main channel and the one or more auxiliary channels.

18. The duct of claim 12, further comprising one or more septa disposed within the bore and dividing the bore into a main channel and one or more auxiliary channels, wherein one of the main channel and the one or more auxiliary channels can be used to accommodate blown optical fibers.

19. The duct of claim 12, comprising two strength members disposed lengthwise within the elongated main body and on opposing sides of the bore.

20. A duct wrapped on a spool for distributing transmission media, comprising:
an elongated main body having a length, a generally flat bottom portion having an adhesive layer disposed thereon, at least one conduit portion adjacent to the flat bottom portion opposite the adhesive, wherein the conduit portion has a lengthwise bore formed therethrough and containing the transmission media; and
at least one strength member disposed lengthwise within the elongated main body and defining a control surface intersecting the bore of the conduit portion of the elongated main body,
wherein the spool comprises a core having a central axis and wherein the duct is wrapped on the core such that at any point along the length of the duct, the control surface is defined by a control line that is parallel to the central axis of the core and intersects the transmission media over a substantial portion of the length of the elongated main body.
